(19) United States
(12) Patent Application Publication
(10) Pub. No.: US 2009/0039663 A1
(43) Pub. Date: Feb. 12, 2009

(54) FOLDING ROPE ANCHOR

(76) Inventor: Kirk M. Mauthner, Invermere (CA)

Correspondence Address: CHRISTIE, PARKER & HALE, LLP, PO BOX 7068, PASADENA, CA, 91109-7068, US

(21) Appl. No.: 11/836,682

(22) Filed: Aug. 9, 2007

(51) Int. Cl. B66C 1/14

(52) U.S. Cl. 294/82.33

(57) ABSTRACT

A rope anchor is provided having a main body and a blade connected to the main body at a first axle. A latch is connected to the main body at a second axle. The latch is adapted to secure the blade in an open position and in a closed position. The rope anchor further includes a means for securing a rope. When the blade is in the closed position, an enclosed gap is located between the blade and the main body.

### BACKGROUND OF THE INVENTION

1. Field of the Invention

The present invention relates generally to a rope anchor, and more particularly, to a folding rope anchor.

2. Description of Related Art

A rope anchor is generally known in the art. FIG. 1 depicts a conventional rope anchor 10 fixed at a window edge 12. As depicted in FIG. 2, the conventional rope anchor 10 is part of an emergency escape system for firefighters that allows a firefighter in danger to quickly deploy the conventional rope anchor 10 and exit out of a window, roof, or other opening of a building. The conventional rope anchor 10 is connected to a rope 11. The rope 11 is also connected to a descent control device 13 attached to a firefighter. Thus, once the conventional rope anchor 10 is deployed, a firefighter may exit from a building and lower himself to safety. FIG. 3 depicts the conventional rope anchor 10 fixed to a remote anchor 14. FIG. 4 depicts the conventional rope anchor 10 fixed with a rope 11 around a substantial object 15. When a remote anchor 15 is wider than a diameter of the conventional rope anchor 10, the conventional rope anchor 10 must be fixed with a rope 11 around the remote anchor 15, with the rope 11 tied to the conventional rope anchor 10.

The conventional rope anchor 10 may be difficult to deploy in some situations. Furthermore, the rope anchor 10 may not be as easy to deploy in other applications such as film and commercial rigging, rescue systems, and sailing and marine applications. Accordingly, a rope anchor is needed that is easier to deploy and is more versatile than the conventional rope anchor 10.

### SUMMARY OF THE INVENTION

A rope anchor is provided having a main body and a blade connected to the main body at a first axle. A latch is connected to the main body at a second axle. The latch is adapted to secure the blade in an open position and in a closed position. The rope anchor further includes a means for securing a rope. When the blade is in the closed position, an enclosed gap is located between the blade and the main body.

In an exemplary embodiment of the present invention, in the open position, the blade extends from the main body at an angle less than or equal to 90°.

In an exemplary embodiment of the present invention, the rope anchor further includes a rectangular-shaped banding for securing an end of the main body.

In an exemplary embodiment of the present invention, the blade and the main body have rounded edges adjacent the enclosed gap.

In an exemplary embodiment of the present invention, the blade has protrusions extending from upper side surfaces.

In an exemplary embodiment of the present invention, on a lower surface, the blade has an upper section and a lower section. The upper section has a concave shape. The lower section has protruding teeth and an angular pointed edge. The upper section extends outside the main body and the lower section extends within the main body when the blade is in the closed position.

In an exemplary embodiment of the present invention, the latch has an engagement protrusion. The engagement protrusion is biased to contact the blade by a spring located at the second axle. The engagement protrusion locks the blade into the open position and the closed position by engaging a first indentation and a second indentation, respectively.

In an exemplary embodiment of the present invention, the main body has a slot and the means for securing a rope include a rounded member around which a rope is wound. The rounded member has a guide pin extending within the slot. The guide pin is adapted to slide within the slot as force is applied to a rope wound around the rounded member.

In an exemplary embodiment of the present invention, the main body has an eye with rounded edges and the means for securing a rope include the eye.

In an exemplary embodiment of the present invention, the blade is biased to the open position by a spring located at the first axle.

In an exemplary embodiment of the present invention, the blade has a blunt end opposite a pointed edge of the blade for allowing for pounding the pointed edge into a surface by striking the blunt end of the blade.

A rope anchor is provided with a main body having an inner compartment and a slot. A blade is connected to the main body at a first axle. A latch is connected to the main body at a second axle. The latch is adapted to secure the blade in an open position and in a closed position. A rounded member having a guide pin is adapted to slide within the slot. The rounded member has a concave channel for securing a rope. When the blade is in the closed position, an enclosed gap is located between the blade and the main body.

### BRIEF DESCRIPTION OF THE DRAWINGS

FIG. 1 depicts a conventional rope anchor fixed at a window edge.

FIG. 2 depicts a firefighter utilizing the conventional rope anchor.

FIG. 3 depicts the conventional rope anchor fixed to a remote anchor.

FIG. 4 depicts the conventional rope anchor fixed with a rope around a substantial object.

FIG. 5 is a side view of a folding rope anchor according to an exemplary embodiment of the present invention.

FIG. 6 is a partial side view of the folding rope anchor according to an exemplary embodiment of the present invention.

FIG. 7 is a partial close-up sectional view of the folding rope anchor showing a means for securing a rope according to an exemplary embodiment of the present invention.

FIG. 8 is a side view of the rounded member according to an exemplary embodiment of the present invention.

FIG. 9 is another side view of the folding rope anchor.

FIG. 10 is a partial sectional view of the folding rope anchor.

FIG. 11 is another internal view of the folding rope anchor.

FIG. 12 is a folding rope anchor according to another exemplary embodiment of the present invention.

FIG. 13 depicts a folding rope anchor fixed at a window edge.

FIG. 14 depicts a folding rope anchor fixed into a building material.

FIG. 15 depicts a folding rope anchor fixed with a rope around a substantial object.

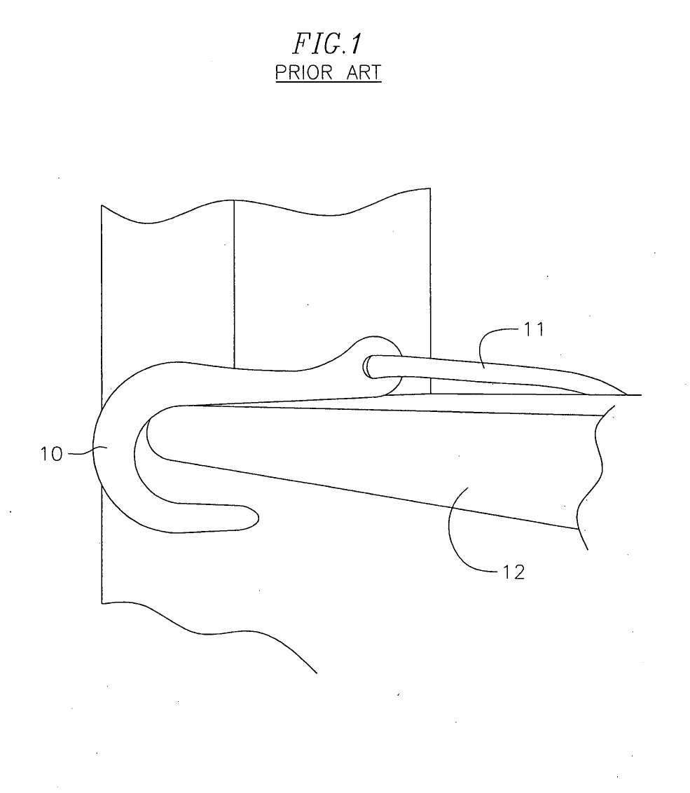

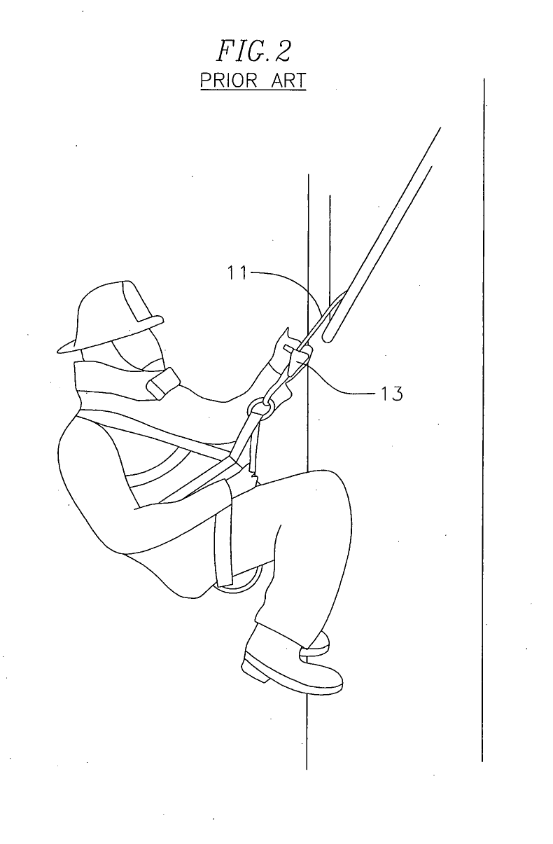

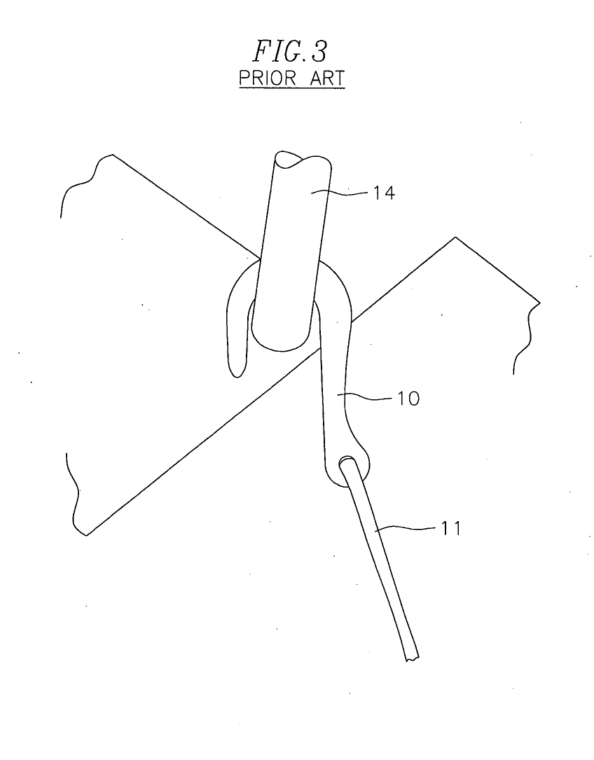

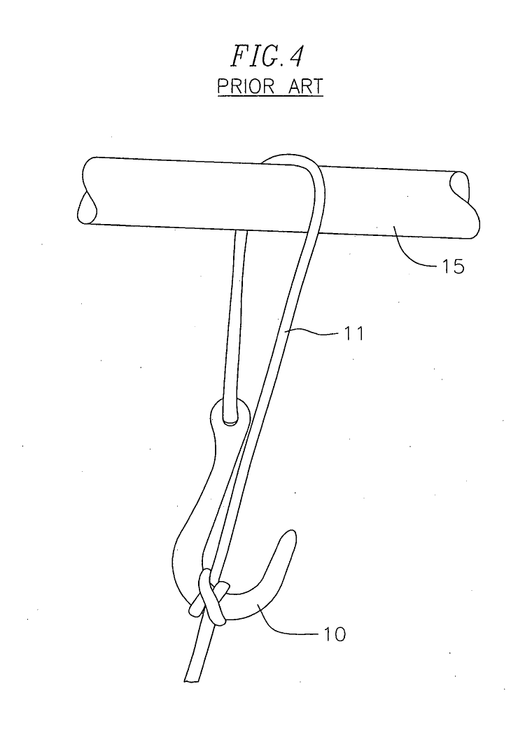

### DETAILED DESCRIPTION

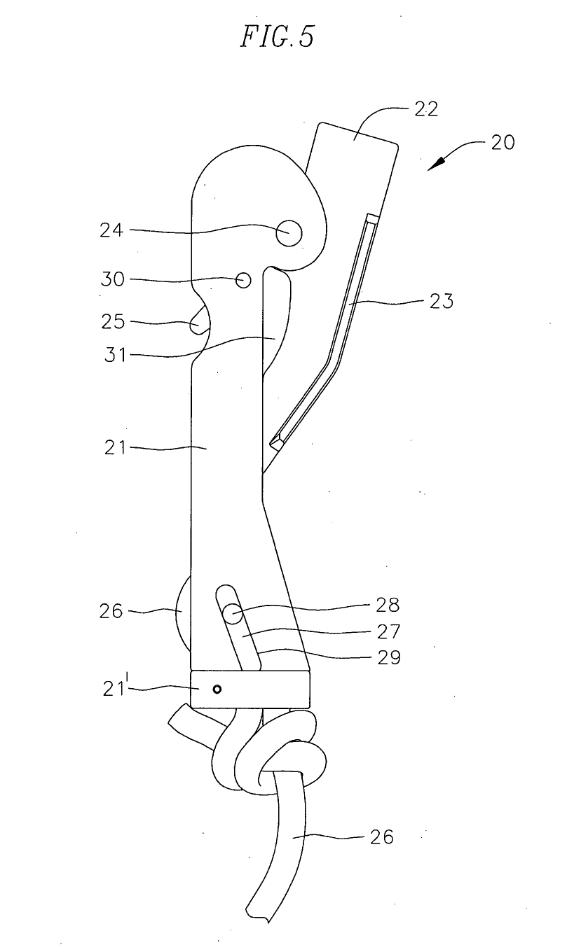

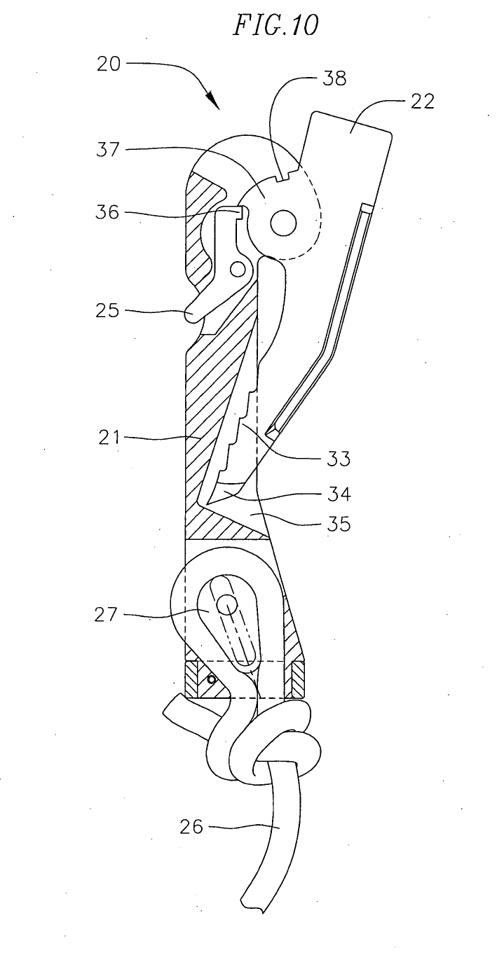

FIG. 5 is a side view of a folding rope anchor 20 according to an exemplary embodiment of the present invention. The folding rope anchor 20 includes a main body 21 with a blade 22 attached to the main body at axle 24. The blade 22 may include a protruding edge/ridge 23 so that a firefighter may easily grasp and open the blade 22. The blade 22 is locked into place by latch 25, which is connected to the main body 21 at axle 30. The latch 25 frees the blade 22 when the latch 25 is pushed in towards the main body 21. The portion of the latch 25 extending outside the main body 21 is biased away from the main body 21 with a spring at axle 30. A portion of the latch opposite the axle 30 inside the main body 21 is biased toward the blade 22 in order to lock the blade 22 in closed (FIG. 5) and open (FIG. 9) positions. When the blade 22 is locked into a closed position as depicted in FIG. 5, a gap 31 is located between the blade 22 and the main body 21. The gap 31 allows for a rope to be locked between the blade 22 and the main body 21. The inner portions of the blade 22 and the main body 21 adjacent the gap 31 (i.e., the edges of the gap 31) have rounded edges so that a rope 26 is not damaged by being rubbed along the edges of the gap 31.

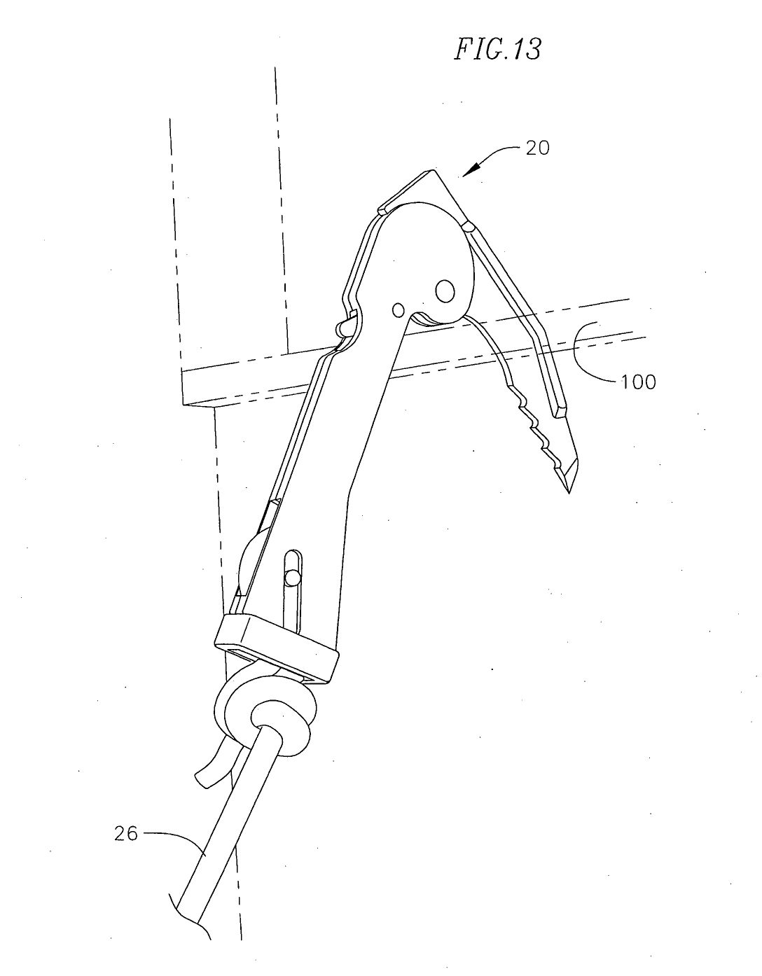

The rope 26 wraps around a rope retention mechanism 27 located internal to the main body 21. The rope retention mechanism 27 has a rounded shape and provides a greater surface area in which the rope may make contact with the folding rope anchor 20. Thus, the rope retention mechanism 27 puts less stress on the rope 26 than an eye 42 (see FIG. 12), and therefore provides a stronger link between the rope 26 and the folding rope anchor 20. The rope retention mechanism 27 includes a guide pin 28 that extends into slot 29 located on one side of the main body 21. As weight is applied to the rope 26, the rope retention mechanism 27 and the guide pin 28 slide down along the slot 29 and pinch the rope 26 between the rope retention mechanism 27 and an internal surface of the main body 21, thus further securing the rope 26 in place.

The folding rope anchor 20 further includes a banding 21′ encircling the rope exit/entry location at a bottom end of the main body 21 for securing the two parts of the main body 21 together. The banding 21′ is rectangular shaped with flat edges. The banding 21′ significantly strengthens the termination mechanism of the main body 21 and the wide profile of the banding 21′ assists in stabilizing the folding rope anchor 20 when the anchor is being used as a hook over a flat-surfaced edge, such as a window ledge.

FIG. 6 is a partial side view of the folding rope anchor 20 according to an exemplary embodiment of the present invention. As depicted in FIG. 6, the rope retention mechanism 27 has a concave inner surface 39 for securing a rope.

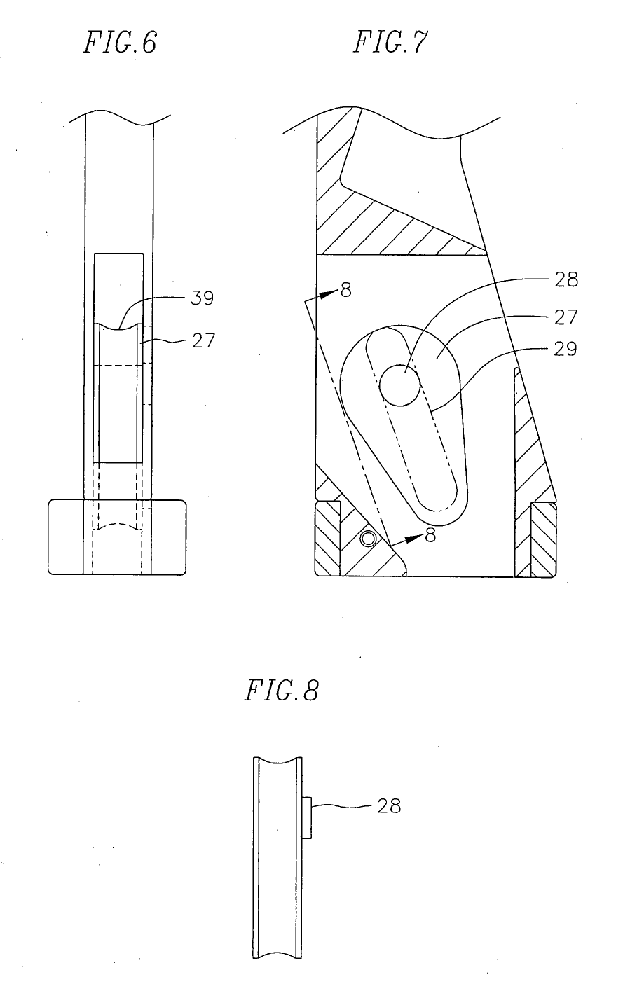

FIG. 7 is a partial close-up sectional view of the folding rope anchor 20 showing a means for securing a rope according to an exemplary embodiment of the present invention. The means for securing a rope include a rope retention mechanism 27 having a concave inner surface 39. The means may also include an eye 42 (see FIG. 12) or otherwise any rounded or circular member having a channel for holding a rope and a means for securing the rope such as a member that pinches the rope in place when force is applied to an attached rope.

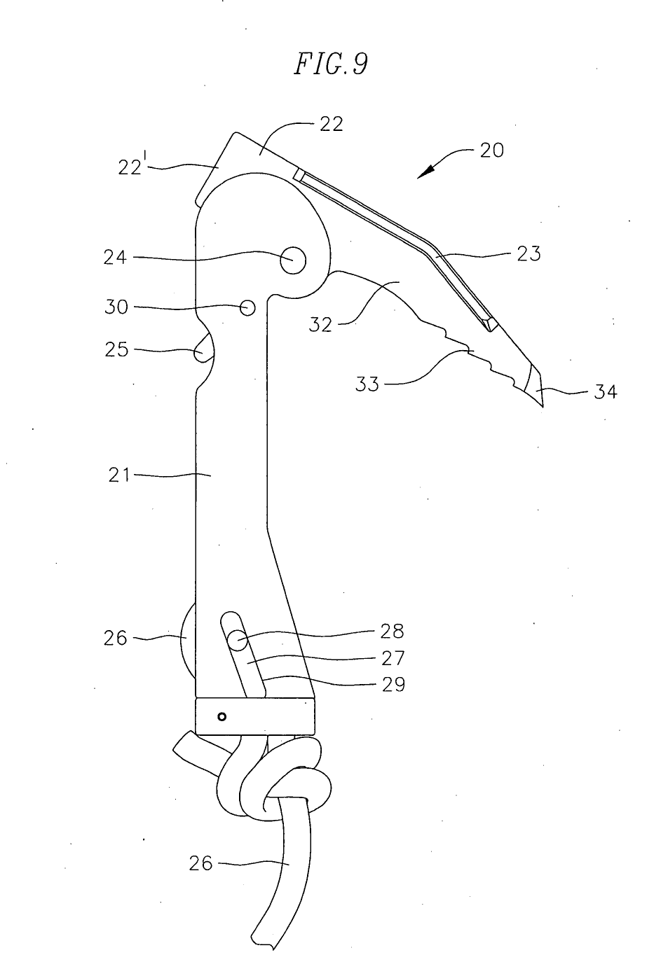

FIG. 8 is a side view of the rope retention mechanism 27 according to an exemplary embodiment of the present invention. As depicted in FIG. 8, the rope retention mechanism 27 includes a guide pin 28 such that the rope retention mechanism 27 remains aligned in the slot 29 of the main body 21.

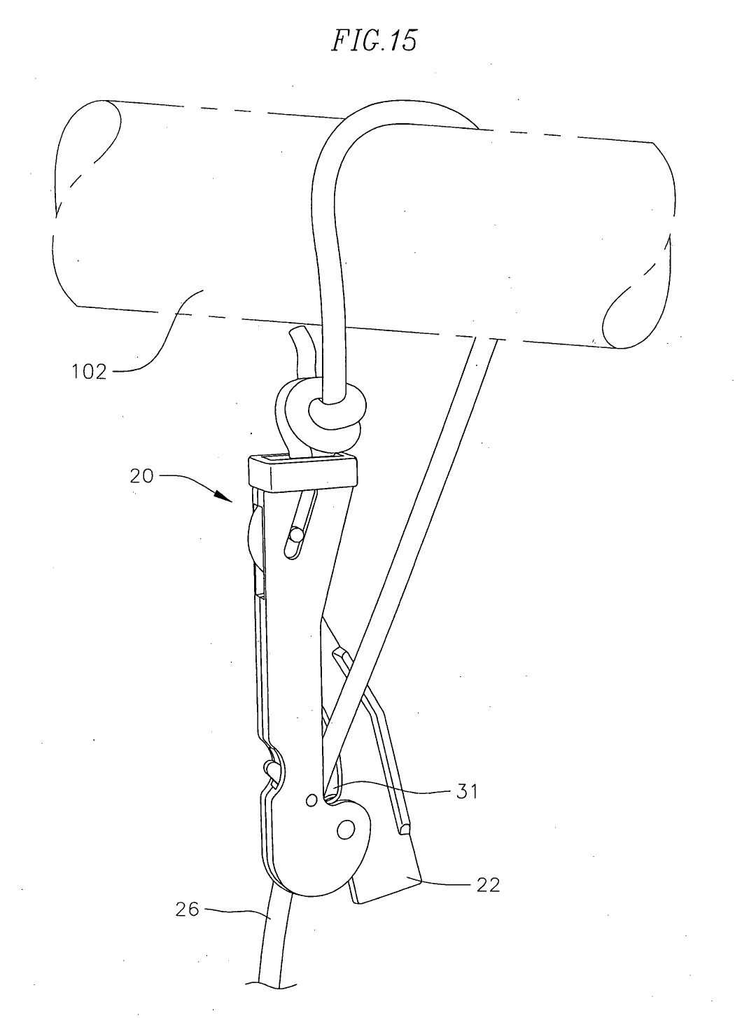

FIG. 9 is another side view of the folding rope anchor 20. In FIG. 9, the folding rope anchor 20 is depicted with the blade 22 in an open position. The blade 22 includes a rounded upper portion 32 such that the rope 26 may be locked between the blade 22 and the main body 21 when the blade is closed (see FIG. 15). The blade 22 also includes teeth 33 for securing the folding rope anchor 20 once the blade is punched through a surface. The blade 22 further includes a pointed edge 34 for allowing the blade 22 to easily enter or otherwise dig into surfaces into which the folding rope anchor 20 is secured and includes opposite the edge 34 a blunt edge 22′ for providing a surface for pounding blade 22 into objects or through securing surfaces.

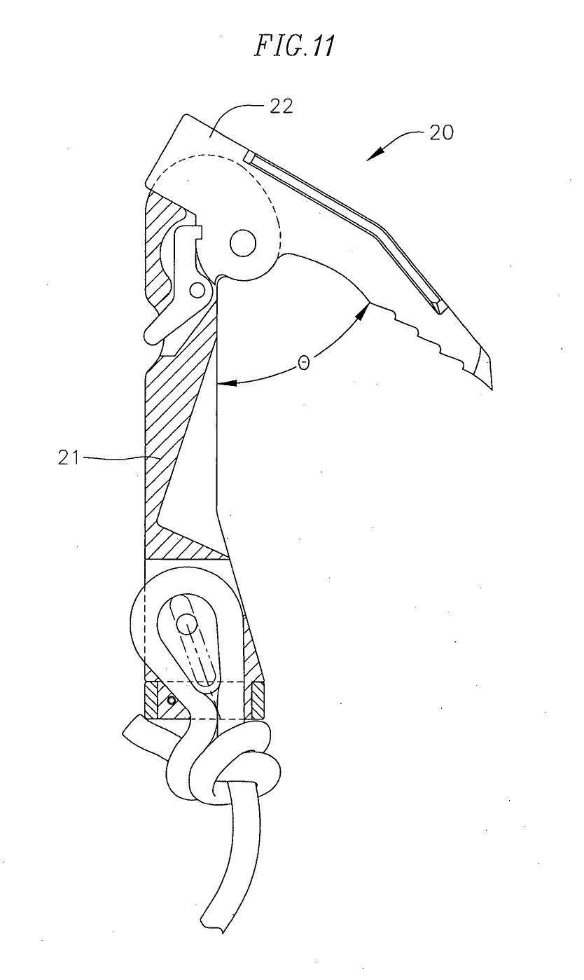

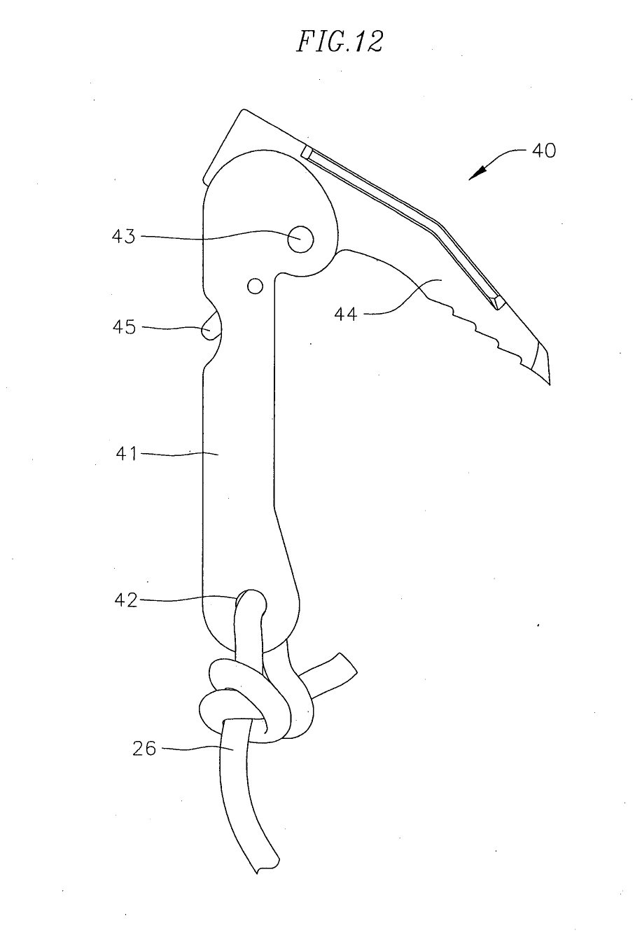

FIG. 10 is an internal view of the folding rope anchor 20. The main body 21 has an inner compartment 35 for protecting the teeth 33 and the pointed edge 34 while the blade 22 is locked in a closed position. The latch 25 has an engagement protrusion 36 biased to make contact with the rounded inner edge portion 37 of blade 22. When the engagement protrusion 36 snaps into the indentation 38, the blade 22 is locked in an open position as depicted in FIG. 11.

FIG. 11 is another internal view of the folding rope anchor 20. When the blade 22 is in a fully open position, the blade 22 extends at an angle θ less than or equal to 90°.

FIG. 12 is a folding rope anchor 40 according to another exemplary embodiment of the present invention. The folding rope anchor 40 may alternatively include an eye 42 in the main body 41 for allowing a rope 26 to be attached to the main body 41. In such an embodiment, the eye 42 has rounded edges so as not to damage the rope 26. In another exemplary embodiment, the axle 43 may include a spring for biasing the blade 44 into an open position. In such an embodiment, the blade 44 snaps open upon pressing the latch 45 into the main body 41.

FIG. 13 depicts a folding rope anchor 20 fixed at a window edge 100. When a firefighter is trapped in a building and must quickly exit the building, a firefighter may deploy the folding rope anchor 20, fix the folding rope anchor 20 to a window edge 100 or other anchoring object, and lower himself down to safety.

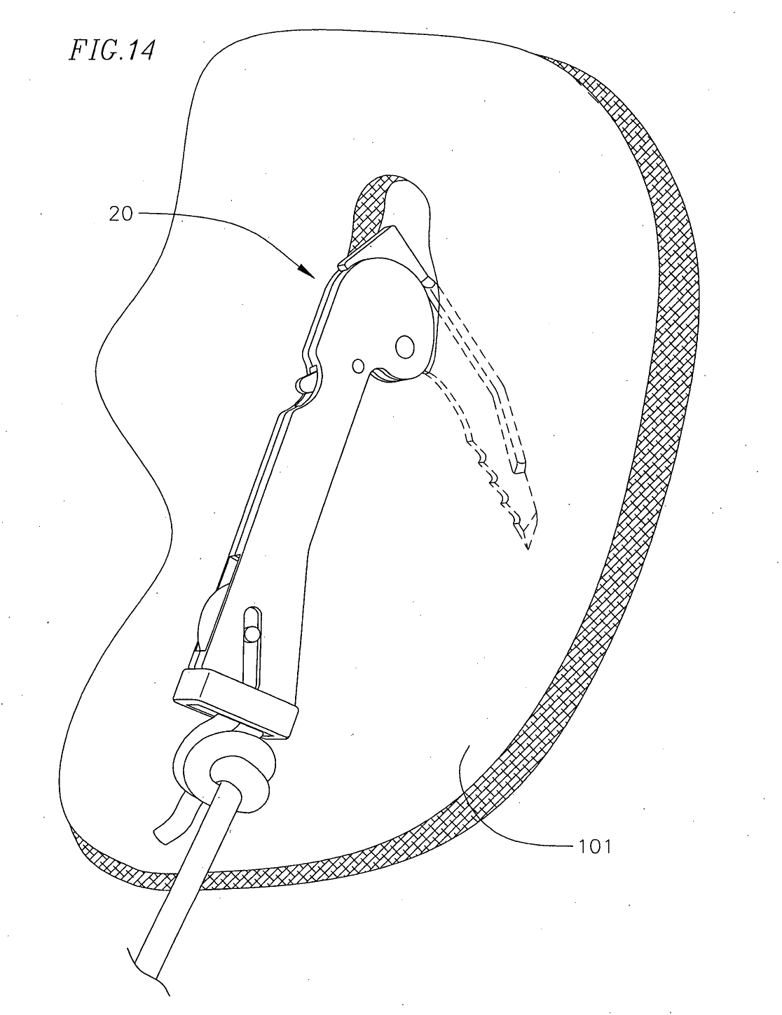

FIG. 14 depicts a folding rope anchor 20 fixed into a building material 101. As depicted in FIG. 14, the folding rope anchor 20 may be fixed to a building material 101, such as a header, studs, roof material, or the like that will prevent the folding rope anchor 20 from unattaching while a force is applied to the rope 26.

FIG. 15 depicts a folding rope anchor 20 fixed with a rope 26 around a substantial object 102. As depicted in FIG. 15, the folding rope anchor 20 may also be fixed to objects 102 around which a loop can be placed. The blade 22 of the folding rope anchor 20 may lock the rope 26 in the gap 31, thus providing a secure anchor for a firefighter's escape.

Although FIG. 13, FIG. 14, and FIG. 15 depict the folding rope anchor 20 being secured to a window edge 100, building material 101, and a substantial object 102, the folding rope anchor 20 may be fixed to any object that provides a sturdy anchor for a firefighter's escape.

Further, although the folding rope anchor 20 may be used in emergency situations such as a firefighter's escape, the folding rope anchor 20 may also be used where other anchor options might not be available. Other possible anchor applications include film and commercial rigging, rescue systems including ice rescues for ice climbers, sailing and marine applications, sport applications, work applications, and any other applications in which a rope must be anchored.

In addition, the folding rope anchor 20 may be used without attaching a rope such as a safety device for someone crossing an icy slope or for an ice climber who needs an ice pick that allows the sharp point to be folded safely away.

While the invention has been described in terms of exemplary embodiments, it is to be understood that the words which have been used are words of description and not of limitation. As is understood by persons of ordinary skill in the art, a variety of modifications can be made without departing from the scope of the invention defined by the following claims, which should be given their fullest, fair scope.

What is claimed is:

1. A rope anchor comprising:
a main body;
a blade connected to the main body at a first axle;
a latch connected to the main body at a second axle, the latch adapted to secure the blade in an open position and in a closed position; and
means for securing a rope;
wherein when the blade is in the closed position, an enclosed gap is located between the blade and the main body.

2. The rope anchor as claimed in claim 1, wherein in the open position, the blade extends from the main body at an angle less than or equal to 90°.

3. The rope anchor as claimed in claim 1, further comprising a rectangular-shaped banding for securing an end of the main body.

4. The rope anchor as claimed in claim 1, wherein the blade and the main body have rounded edges adjacent the enclosed gap.

5. The rope anchor as claimed in claim 1, wherein the blade has protrusions extending from upper side surfaces.

6. The rope anchor as claimed in claim 1, wherein on a lower surface, the blade has an upper section and a lower section, the upper section having a concave shape, the lower section having protruding teeth and an angular pointed edge, the upper section extending outside the main body and the lower section extending within the main body when the blade is in the closed position.

7. The rope anchor as claimed in claim 1, wherein the latch has an engagement protrusion, the engagement protrusion being biased to contact the blade by a spring located at the second axle, the engagement protrusion locking the blade into the open position and the closed position by engaging a first indentation and a second indentation, respectively.

8. The rope anchor as claimed in claim 1, wherein the main body has a slot and the means for securing a rope include a rounded member around which a rope is wound, the rounded member having a guide pin extending within the slot, the guide pin being adapted to slide within the slot as force is applied to a rope wound around the rounded member.

9. The rope anchor as claimed in claim 1, wherein the main body has an eye with rounded edges and the means for securing a rope include the eye.

10. The rope anchor as claimed in claim 1, wherein the blade is biased to the open position by a spring located at the first axle.

11. The rope anchor as claimed in claim 1, wherein the blade has a blunt end opposite a pointed edge of the blade for allowing for pounding the pointed edge into a surface by striking the blunt end of the blade.

12. A rope anchor comprising:
a main body having an inner compartment and a slot;
a blade connected to the main body at a first axle;
a latch connected to the main body at a second axle, the latch adapted to secure the blade in an open position and in a closed position; and
a rounded member having a guide pin adapted to slide within the slot and having a concave channel for securing a rope;
wherein when the blade is in the closed position, an enclosed gap is located between the blade and the main body.

13. The rope anchor as claimed in claim 12, wherein in the open position, the blade extends from the main body at an angle less than or equal to 90°.

14. The rope anchor as claimed in claim 12, further comprising a rectangular-shaped banding for securing an end of the main body.

15. The rope anchor as claimed in claim 12, wherein the blade and the main body have rounded edges adjacent the enclosed gap.

16. The rope anchor as claimed in claim 15, wherein the blade has protrusions extending from upper side surfaces.

17. The rope anchor as claimed in claim 16, wherein on a lower surface, the blade has an upper section and a lower section, the upper section having a concave shape, the lower section having protruding teeth and an angular pointed edge, the upper section extending outside the main body and the lower section extending within the inner compartment when the blade is in the closed position.

18. The rope anchor as claimed in claim 17, wherein the latch has an engagement protrusion, the engagement protrusion being biased to contact the blade by a spring located at the second axle, the engagement protrusion locking the blade into the open position and the closed position by engaging a first indentation and a second indentation, respectively.

19. The rope anchor as claimed in claim 18, wherein the blade has a blunt end opposite the angular pointed edge for allowing for pounding the angular pointed edge into a surface by striking the blunt end of the blade.
